(19) United States
(12) Patent Application Publication
(10) Pub. No.: US 2026/0144275 A1
(43) Pub. Date: May 28, 2026

(54) EXTRUSION METHODS AND FLAVORED PRODUCTS FORMED THEREBY

(71) Applicant: Firmenich SA, Satigny (CH)

(72) Inventors: Igor BODNAR, Satigny (CH); Narendra SISODIA, Satigny (CH); Mirela PASCU, Satigny (CH); Howard MUNT, Satigny (CH)

(73) Assignee: Firmenich SA, Satigny (CH)

(21) Appl. No.: 19/118,912

(22) PCT Filed: Oct. 24, 2023
(86) PCT No.: PCT/EP2023/079624

§ 371 Date: Apr. 7, 2025

Related U.S. Application Data
(60) Provisional application No. 63/419,401, filed on Oct. 26, 2022.

(30) Foreign Application Priority Data
Nov. 2, 2022 (EP) 22205145.0

(51) Int. Cl. A23J 3/26; A23C 20/02; A23J 3/14; A23J 3/22; A23L 11/00; A23L 27/00; A23P 30/20

(52) U.S. Cl. CPC A23J 3/26; A23C 20/025; A23J 3/14; A23J 3/227; A23L 11/00; A23L 27/00; A23P 30/20; A23V 2002/00

(57) ABSTRACT

The present disclosure relates generally to extruded food products that contain one or more aroma compounds. In some embodiments, the extruded food products are products that contain non-animal proteins, such as vegan analogues of meat products, dairy products, and seafood products. In some embodiments, the one or more aroma compounds are not distributed uniformly throughout the product but, instead, have a higher concentration at or near the external surfaces of the extruded food product. In certain related aspects, the disclosure provides methods of making such extruded food products. In some embodiments, the methods comprise introducing one or more aroma compounds following extrusion.

### TECHNICAL FIELD

The present disclosure relates generally to extruded food products that contain one or more flavor compounds. In some embodiments, the extruded food products are products that contain non-animal proteins, such as vegan analogues of meat products, dairy products, and seafood products. In some embodiments, the one or more aroma compounds are not distributed uniformly throughout the product but, instead, have a higher concentration at or near the external surfaces of the extruded food product. In certain related aspects, the disclosure provides methods of making such extruded food products. In some embodiments, the methods comprise introducing one or more aroma compounds following extrusion.

### DESCRIPTION OF RELATED ART

Extrusion is a common technique for making various food products, especially food products that are produced on a large scale. Extrusion works by forcing a soft composition through a plate or die designed to produce a certain shape. As the soft composition is forced through the plate or die, a blade shears the extrudate to form food articles having a certain length. Examples of products manufactured by extrusion include pasta, breakfast cereals, ready-to-eat snacks, confectionary products, and the like. In many cases, these extruded food products are starchy food products, as high-starch compositions have a soft consistency that is amenable to processing by extrusion.

There is growing consumer demand for vegan analogues of various meat, dairy, or seafood products. Such products employ non-animal proteins in combination with various plant fibers, lipid compounds, and flavorings to approximate the texture and flavor of their animal- or seafood-derived counterparts. Further, such analogue products typically have a shape similar to the shape in which the corresponding meat, dairy, or seafood product is often consumed. For example, a vegan chicken cutlet would have a shape typical of an actual chicken cutlet. Using molds can provide a suitable means of making such products. That's especially true when forming the product relies on gelation to occur to achieve suitable shape retention. But forming such products using molds can be inefficient and lead to difficulty in scaling up such processes and keeping manufacturing costs low.

Extrusion may offer one possibility for overcoming some of the problems associated with scalability and cost. Therefore, there is a continuing need to develop processes for making analogues of meat, dairy, and seafood using extrusion methods.

### SUMMARY

The present disclosure relates to the discovery of certain extrusion processes and extruded materials that have improved retention of aroma compounds, which improves the flavor profile for food products comprising non-animal proteins.

In a first aspect, the disclosure provides a method of making a flavored article, comprising: (a) providing a comestible composition in a form suitable for extrusion; (b) extruding the comestible composition to form an extruded comestible composition; (c) cutting the extruded comestible composition to form one or more comestible articles; and (d) introducing a flavoring composition to the one or more comestible articles to form one or more flavored articles. In some embodiments, the comestible composition comprises a non-animal protein, such as a plant protein. In some embodiments, the flavoring composition comprises a volatile flavor compound, a nonvolatile flavor compound, or any combination thereof. In some embodiments, the flavored article is a meat analogue product, a seafood analogue product, a cheese analogue product, or a dairy analogue product.

In a second aspect, the disclosure provides a method of making a flavored article, comprising: (a) providing a comestible composition in a form suitable for extrusion; (b) extruding the comestible composition to form an extruded comestible composition; (c) introducing a flavoring composition to the extruded comestible composition to form a flavored extruded comestible composition; and (d) cutting the flavored extruded comestible composition to form one or more flavored articles. In some embodiments, the comestible composition comprises a non-animal protein, such as a plant protein. In some embodiments, the flavoring composition comprises a volatile flavor compound, a nonvolatile flavor compound, or any combination thereof. In some embodiments, the flavored article is a meat analogue product, a seafood analogue product, a cheese analogue product, or a dairy analogue product.

In a third aspect, the disclosure provides a flavored article formed by the method of the first aspect or the second aspect, or any embodiments thereof. In some embodiments, the flavored article is a meat analogue product, a seafood analogue product, a cheese analogue product, or a dairy analogue product.

Further aspects, and embodiments thereof, are set forth below in the Detailed Description, the Abstract, and the Claims.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

Unless specified otherwise, numerical ranges expressed in the format “from x to y” are understood to include x and y. When for a specific feature multiple preferred ranges are described in the format “from x to y”, it is understood that all ranges combining the different endpoints are also contemplated.

The term “fat” used in the present disclosure refers to lipid components that are solid or in the form of a paste at 20° C. whereas the term “oil” used in the present disclosure refers to lipid components that are liquid at 20° C. But for convenience the term “fat content” refers to the content of both oil and fat in a comestible composition.

The term “emulsion”, as used herein, denotes a mixture of two or more liquids that are normally immiscible (i.e. not mixable). In an emulsion, one liquid (the dispersed phase) is dispersed in the other (the continuous phase). In the present disclosure, it is described an oil-in water emulsions comprising a continuous hydrophilic phase comprising water, in which the hydrophobic phase is dispersed.

The melting profile can be measured by differential scanning calorimeter Q2000 (TA Instruments, New Castle, DE, USA). Typically, small samples (5˜10 mg) are sealed in hermetic aluminum pans (Tzero, T161003). Typically, the program consists of the following steps: equilibrate at −20° C. for 5 minutes, ramp to 100° C. at 10° C./min, cooling to −20° C., hold isothermal at −20° C. for 5 min and ramp to 100° C. at 10° C./min. The instrument was calibrated for the melting temperature and enthalpy of fusion of Indium (Standard Reference Material 2232, National Institute of Standards and Technology, Gaithersburg, MD). DSC is widely used to determine percent of fat melted at a certain temperature. This technique is based on measuring the heat of fusion successively at different temperatures. The melting peak temperature and enthalpy of fusion can be obtained using “integrate peak linear” for each DSC curve. The melting peak temperature is the peak temperature of the phase transition curve via DSC. By reference to the total melting heat, the fraction of fat melted is determined. The method is described in “Cassel RB. Determining percent solid in an edible fat. TA Instruments Applications Brief TA290. 2002”. The melting profile is taken from the first heating ramp (scan) of the DSC curve at 10° C./min. The percentage of the solid lipid melted as a function of temperature can be calculated using ‘running integral’. Tₘ represents melting peak temperature, T_{50%} represents the temperature at which 50% by weight of solid lipid melts, T_{95%} represents the temperature at which 95% by weight of solid lipid melts.

In case of combination of more than two components, the melting profile of the mixture can be obtained by the same method as described previously.

By “melting temperature T_{50%}”, it is meant the temperature at which 50% by weight of plant-based fat melts.

By “melting temperature T_{95%}”, it is meant the temperature at which 95% by weight of plant-based fat melts.

Tₘ, T_{50%} and T₉₅% are well-known parameters used by the skilled person in the art. It can be easily determined by DSC (Differential Scanning Calorimetry) as described above.

By “plant-based fat”, it is meant a compound chosen in the group consisting of glycerides, fatty acids, hydrogenated oils that derived from plants.

By “flavor oil” it is meant here a flavoring ingredient or a mixture of flavoring ingredients.

By “perfume oil” it is meant here a perfuming ingredient or a mixture of perfuming ingredients. “Emulsifiers” are amphiphilic molecules that concentrate at the interface between two phases and modify the properties of that interface. Examples of emulsifiers can be found in McCutcheon's Emulsifiers & Detergents or the Industrial Surfactants Handbook.

Other terms are defined in other portions of this description, even though not included in this subsection.

### Comestible Compositions

The present disclosure provides an extrusion process, and flavored articles formed thereby, which use a comestible composition as the starting material. In general, the comestible compositions are in the form of a deformable material suitable for use in a wide variety of commonly used extruders.

In some embodiments, the comestible composition comprises a non-animal protein, such as a plant protein, an algal protein, or a mycoprotein. In some embodiments, the comestible composition comprises a plant protein. Non-limiting examples of such plant proteins include pea protein, soy protein, almond protein, cashew protein, canola (rapeseed) protein, chickpea protein, fava protein, sunflower protein, wheat protein, oat protein, and potato protein. In some embodiments, the comestible composition comprises pea protein. In some embodiments, the comestible composition comprises soy protein. The non-animal proteins can make up any suitable proportion of the comestible composition. For example, in some embodiments, the non-animal protein makes up from 1 percent by weight to 99 percent by weight, or from 2 percent by weight to 90 percent by weight, or from 5 percent by weight to 80 percent by weight, or from 5 percent by weight to 70 percent by weight, or from 5 percent by weight to 60 percent by weight, or from 5 percent by weight to 50 percent by weight, of the comestible composition, based on the total weight of the comestible composition. In some embodiments, the comestible composition comprises a non-animal protein (according to any of the above embodiments) and an animal protein, such as a dairy protein. The non-animal and animal proteins can be in any suitable form, such as protein concentrates, protein isolates, and the like.

In some embodiments, the comestible composition comprises lipid materials, such as fats, oils, or any combinations thereof. Any suitable fats and oils can be used, such as non-animal fats and oils, including oils and fats derived from plants, algae, fungi, and the like. In some embodiments, the lipid material comprises vegetable fats or oils derived from various plants or seeds, such as olives, canola (rapeseed), peanuts, avocado, almond, hazelnut pecan, pumpkin, walnut, sunflower, safflower, corn, soybean, jatropha, grapeseed, cottonseed, palm, palm kernel, coconut, cocoa, sesame, hemp, mustard, rice bran, and the like. In some embodiments, the comestible composition comprises coconut fat. Such fats or oils can be present in any suitable concentration within the comestible composition. For example, in some embodiments, such fats or oils are present in the comestible composition at a concentration ranging from 1 percent by weight to 25 percent by weight, or from 1 percent by weight to 20 percent by weight, or from 1 percent by weight to 15 percent by weight, or from 1 percent by weight to 12 percent by weight, or from 1 percent by weight to 10 percent by weight, or from 1 percent by weight to 7 percent by weight, or from 2 percent by weight to 5 percent by weight, based on the total weight of the comestible composition.

In some embodiments, the comestible composition comprises one or more soluble fibers. As used herein, the term “soluble fiber” refers to polysaccharides characterized as being soluble using the method of the Association of Official Analytical Chemists (AOAC) as set forth in Prosky et al., J. ASSOC. OFF. ANAL. CHEM., vol. 70(5), pp. 1017-1023 (1988). Any suitable soluble fibers can be used, including, but not limited to, fruit fibers (such as citrus fibers), grain fibers, psyllium husk fibers, other natural soluble fibers, and synthetic soluble fibers. Natural soluble fibers include, but are not limited to, soluble corn fibers, maltodextrins, acacia fibers, and hydrolyzed guar gum. Synthetic soluble fibers include, but are not limited to, polydextrose, modified food starches, and the like. Non-limiting examples of food-grade sources of soluble fiber include, but are not limited to, inulin, corn fiber, barley fiber, corn germ, ground oat hulls, milled corn bran, derivatives of the aleurone layer of wheat bran, flax flour, whole flaxseed bran, winter barley flake, ground course kilned oat groats, maize, pea fiber (e.g., Canadian yellow pea), Danish potatoes, konjac vegetable fiber (glucomannan), psyllium fiber from seed husks of planago ovate, psyllium husk, liquid agave fiber, rice bran, oat sprout fibers, amaranth sprout fiber, lentil flour, grape seed fiber, apple fiber, blueberry fiber, cranberry fiber, fig fiber, ciranda power, carob powder, milled prune fiber, mango fiber, orange fiber, orange pulp, strawberry fiber, carrageenan hydrocolloid, derivatives of eucheuma cottonnil seaweed, cottonseed fiber, soya fiber, kiwi fiber, acacia gum fiber, bamboo fiber, chia fiber, potato fiber, potato starch, pectin (carbohydrate) fiber, hydrolyzed guar gum, carrot fiber, chicory root fiber, oat fiber, wheat fiber, tomato fiber, polydextrose fiber, refined corn starch syrup, isomalto-oligosaccharide mixtures, soluble dextrin, mixtures of citrus bioflavonoids, cell-wall broken nutritional yeast, lipophilic fiber, plum juice fiber, derivatives from larch trees, olygose fiber, derivatives from cane sugar, short-chain fructo-oligosaccharides, synthetic polymers of glucose, polydextrose, pectin, polyanionic compounds, cellulose fibers, cellulose fibers derived from hard wood plants, and carboxymethyl cellulose. Such insoluble fibers can be included in the comestible composition in any suitable concentration. For example, in some embodiments, soluble fibers are present in the comestible composition at a concentration ranging from 1 percent by weight to 25 percent by weight, or from 1 percent by weight to 20 percent by weight, or from 1 percent by weight to 15 percent by weight, or from 1 percent by weight to 12 percent by weight, or from 1 percent by weight to 10 percent by weight, or from 1 percent by weight to 7 percent by weight, or from 1 percent by weight to 5 percent by weight, based on the total weight of the comestible composition.

In some embodiments, the comestible composition comprises one or more insoluble fibers. Such insoluble fibers can provide structure and texture to the comestible composition. Any suitable insoluble fibers can be used. In some embodiments, the insoluble fiber is a plant-derived fiber. Non-limiting examples include nut fibers, grain fibers, rice fibers, seed fibers, oat fibers, pea fibers, potato fibers, berry fibers, soybean fibers, banana fibers, citrus fibers, apple fibers, and carrot fibers. In some embodiments, the insoluble fiber is pea fiber. The insoluble fiber can make up any suitable proportion of the comestible composition. For example, in some embodiments, the insoluble fiber makes up from 1 percent by weight to 50 percent by weight, or from 1 percent by weight to 40 percent by weight, or from 1 percent by weight to 30 percent by weight, or from 1 percent by weight to 20 percent by weight, of the comestible composition, based on the total weight of the comestible composition.

In some embodiments, the comestible composition comprises one or more natural extracts to provide color, flavor, and the like. The term colorant includes FD&C colors, such as blue no. 1, blue no. 2, green no. 3, red no. 3, red no. 40, yellow no. 5, yellow no. 6, and the like. Natural colorants or coloring food stuff, such as caramel coloring, annatto, chlorophyllin, cochineal, betanin, turmeric, saffron, paprika, lycopene, elderberry juice, pandan, butterfly pea and the like, as well as titanium dioxide, carbon carbonate, or any suitable food colorant known to those of skill in the art. In some embodiments, the colorant is selected from bell pepper extract, beetroot extract, carrot extract, black current extract, malted barley powder, or any combination thereof. In some embodiments, the comestible composition comprises beetroot extract. The beetroot extract can be used to provide a red color characteristic of uncooked red meat products.

In some embodiments, the comestible compositions disclosed herein comprise a flavoring. In general, the flavoring improves the taste and flavor of the comestible composition or the resulting flavored product in which the comestible composition is used. Such improvement includes reducing the bitterness of the comestible composition or the resulting flavored product, reducing the perception of astringency of the comestible composition or the resulting flavored product, reducing the perception of green taste notes (such as pea taste) of the comestible composition or the resulting flavored product, reducing the perception of cereal notes of the comestible composition or the resulting flavored product, improving the perception of creaminess of the comestible composition or the resulting flavored product, improving the perception of creaminess of the comestible composition or the resulting flavored product, improving the perception of fattiness of the comestible composition or the resulting flavored product, improving the perception of sweetness of the comestible composition or the resulting flavored product, improving the perception of savory taste (umami or kokumi) of the comestible composition or the resulting flavored product, improving the mouthfeel or mouthcoating of the comestible composition or the resulting flavored product, improving the perception of juiciness of the comestible composition or the resulting flavored product, improving the perception of thickness of the comestible composition or the resulting flavored product, improving the vanillic character of the comestible composition or the resulting flavored product, or any combination thereof.

Any suitable flavoring can be used. In some embodiments, the flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Non-limiting examples of other flavors include natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish creme, white chocolate, raspberry, pumpkin pie spice, peppermint, or any combination thereof. In

In some embodiments, the flavoring is a meat flavoring, or other flavorings commonly used in the context of savory products. Such flavorings include glutamates, arginates, avocadene, avocadyne, a purine ribonucleitide (such as inosine monophosphate (IMP), guanosine monophosphate (GMP), hypoxanthine, inosine), a yeast extract, a fermented food product, cheese, garlic or extracts thereof, a gamma-glutamyl-containing polypeptide, a gamma-glutamyl-containing oligopeptide (such as gamma-glutamyl-containing tripeptides); an flavor-modifying composition (such as a cinnamic acid amide or a derivative thereof), a nucleotide, an oligonucleotide, a plant extract, a food extract, or any combinations thereof.

In some embodiments, the flavoring comprises a yeast extract, such as a yeast lysate. Such extracts can be obtained from any suitable yeast strain, where such extracts are suitable for human consumption. Non-limiting examples of such yeasts include: yeasts of the genus Saccharomyces, such as Saccharomyces cerevisiae or Saccharomyces pastorianus; yeasts of the genus Candida, such as Candida utilis; yeasts of the genus Kluyveromyces, such as Kluyveromyces lactis or Kluyveromyces marxianus; yeasts of the genus Pichia such as Pichia pastoris; yeasts of the genus Debaryomyces such as Debaryomyces hansenii; and yeasts of the genus Zygosaccharomyces such as Zygosaccharomyces mellis. In some embodiments, the yeast is a yeast collected after brewing beer, sake, or the like. In some embodiments, the yeast is a yeast subjected to drying treatment (dried yeast) after collection.

Such extracts can be produced by any suitable means. In general, yeast extracts or lysates are made by extracting the contents of the yeast cells from the cell wall material. In many instances, the digestive enzymes in the cells (or additional enzymes added to the composition) break down the proteins and polynucleotides in the yeast to amino acids, oligopeptides (for example, from 2 to 10 peptides), nucleotides, oligonucleotides (from 2 to 10 nucleotides), and mixtures thereof. A yeast lysate can be prepared by lysing a yeast. For example, in some embodiments, the yeast after culture is crushed or lysed by an enzymatic decomposition method, a self-digestion method, an alkaline extraction method, a hot water extraction method, an acid decomposition method, an ultrasonic crushing method, crushing with a homogenizer, a freezing-thawing method, or the like (two or more thereof may be used in combination), whereby a yeast lysate is obtained. Yeast may be cultured by a conventional method. In some embodiments, the yeast after culture is heat-treated and then treated with a lytic enzyme to obtain an enzyme lysate. The conditions for the heat treatment are, for example, 80° C. to 90° C. for 5 minutes to 30 minutes. As the lytic enzyme used for the enzymatic decomposition method, various enzymes can be used as long as they can lyse the cell wall of yeast. The reaction conditions may be set so as to be optimum or suitable for the lytic enzyme(s) to be used, and specific examples thereof can include a temperature of 50° C. to 60° C., and a pH of 7.0 to 8.0. The reaction time is also not particularly limited, and can be, for example, 3 hours to 5 hours.

Compositions comprising yeast lysate can be obtained from a variety of commercial sources. For example, in some embodiments, the yeast lysate is provides by the flavoring additive sold under the name MODUMAX (DSM Food Specialties BV, Delft, Netherlands).

In some embodiments, the flavoring comprises one or more flavor-modifying compounds, such as compounds that enhance sweetness (e.g., phloretin, naringenin, glucosylated steviol glycosides, etc.), compounds that block bitterness, compounds that enhance umami, compounds that enhance kokumi, compounds that reduce sourness or licorice taste, compounds that enhance saltiness, compounds that enhance a cooling effect, compounds that enhance mouthfeel, or any combinations of the foregoing.

Thus, in some embodiments, the flavoring comprises one or more sweetness enhancing compounds. Such sweetness enhancing compounds include, but are not limited to, naturally derived compounds, such as hesperitin dihydrochalcone, hesperitin dihydrochalcone-4′-O′glucoside, neohesperitin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth. In some embodiments of any of the preceding embodiments, the comestible composition comprises 3-((4-amino-2,2-dioxo-1H-benzo[c][1,2,6]thiadiazin-5-yl)oxy)-2,2-dimethyl-N-propyl-propanamide or N-(1-((4-amino-2,2-dioxo-1H-benzo[c][1,2,6]thiadiazin-5-yl)oxy)-2-methyl-propan-2-yl)isonicotinamide. In some embodiments, the flavoring comprises rebaudioside A, rebaudioside D, or rebaudioside M as a sweetness enhancer.

In some further embodiments, the flavoring comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl)decane-3,5-diol diacetate. In some embodiments, the umami-enhancing compound is N-(heptan-4-yl)benzo[d][1,3]dioxole-5-carboxamide.

In some further embodiments, the flavoring comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, the flavoring comprises one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759. In some embodiments, the bitterness blocking compound is 3-(1-((3,5-dimethylisoxazol-4-yl)-methyl)-1H-pyrazol-4-yl)-1-(3-hydroxybenzyl)-imidazolidine-2,4-dione.

In some further embodiments, the flavoring comprises one or more sour taste modulating compounds, such as acetic acid, citric acid, ascorbic acid, malonic acid, lactic acid, malic acid, and the like.

In some further embodiments, the flavoring comprises one or more mouthfeel modifying compounds. Such mouthfeel modifying compounds include, but are not limited to, tannins, cellulosic materials, bamboo powder, and the like.

In some further embodiments, the flavoring comprises one or more flavor masking compounds. Such flavor masking compounds include, but are not limited to, cellulosic materials, materials extracted from fungus, materials extracted from plants, citric acid, carbonic acid (or carbonates), and the like.

In some embodiments, the flavor-modifying compounds described above are included to improve other tastants that may be present in the comestible composition itself, or that may be included within the flavored products that employ such compositions. Such tastants include sweeteners, umami tastants, kokumi tastants, bitter tastants, sour tastants, and the like.

For example, in some embodiments, the comestible composition or the resulting flavored product comprises a sweetener. The sweetener can be present in any suitable concentration, depending on factors such as the sweetener's potency as a sweetener, its solubility, and the like. For example, in some embodiments, the sweetener is present in an amount ranging from 0.1 percent by weight to 12 percent by weight. This is particularly true when the sweetener is a carbohydrate sweetener, such as sucrose, fructose (including high-fructose corn syrup, fruit juice, and the like), glucose, xylitol, erythritol, allulose, or any combinations thereof. In some other embodiments, the sweetener is present in an amount ranging from 10 ppm to 1000 ppm. Such lower concentrations may be more typical when the sweetener is a higher-potency sweetener such as a steviol glycoside (such as rebaudioside A, rebaudioside B, rebaudioside D, rebaudioside E, rebaudioside M, or any combination thereof), a mogroside (such as mogroside III, mogroside IV, mogroside V, siamenoside I, isomogroside V, mogroside IV_{E}, isomogroside IV, mogroside III_{E}, 11-oxomogroside V, the 1,6-αisomer of siamenoside I, and any combinations thereof), a derivative of either of the foregoing, such as glycoside derivatives (e.g., glucosylates), cyclamate, aspartame, neotame, sucralose, acesulfame K, or any combinations thereof.

In general, the comestible compositions can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some other embodiments, the sweetener is agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In some embodiments, the comestible composition comprises a bitter tastant, such as any compound that agonizes one or more T2R taste receptors. Such bitter tastants include potassium chloride, caffeine, plant proteins, vitamins, minerals, caffeine, and the like.

In some embodiments, the comestible composition comprises one or more umami or kokumi tastants. Such tastants include glutamates, arginates, avocadene, avocadyne, a purine ribonucleitide (such as inosine monophosphate (IMP), guanosine monophosphate (GMP), hypoxanthine, inosine), a yeast extract (as described in further detail above), a fermented food product, cheese, garlic or extracts thereof, a gamma-glutamyl-containing polypeptide, a gamma-glutamyl-containing oligopeptide (such as gamma-glutamyl-containing tripeptides); an flavor-modifying composition (such as a cinnamic acid amide or a derivative thereof), a nucleotide, an oligonucleotide, a plant extract, a food extract, sodium chloride, any salt substitute, and the like.

In some embodiments, the comestible composition comprises an emulsifier, such as a non-hydrocolloid emulsifier. Any suitable non-hydrocolloid emulsifier can be used. For example, in some non-limiting embodiments, the emulsifier comprises lecithin, monoglycerides, diglycerides, polysorbates, vegetable oils, and the like. In some embodiments, the emulsifier comprises lecithin. The emulsifier can be present in any suitable concentration, which can be adjusted so as to form a stable emulsion of the other components in the comestible composition, for example, when incorporated into a flavored product.

In some embodiments, it may be desirable to include additives that assist in adjusting the viscosity of the comestible composition. Various salts and acids can be used to carry out such adjustments. In some embodiments, the comestible composition comprises one or more salts. Non-limiting examples of suitable salts include magnesium sulfate, sodium chloride, sodium sulfate, calcium chloride, calcium sulfate, potassium sulfate, potassium chloride, potassium sorbate, potassium phosphate, potassium monophosphate, zinc chloride, zinc sulfate, or any mixtures thereof. In some embodiments, the comestible composition also comprises one or more acids, which may be used alone or in combination with the aforementioned salts. Non-limiting examples of suitable acids include citric acid, lactic acid, acetic acid, tartaric acid, succinic acid, ascorbic acid, maleic acid, phosphoric acid, monopotassium phosphate, gluconic acid, glucono-lactone, glucoronic acid, glycyrrhetic acid, folic acid, pantothenic acid or mixtures thereof.

In some embodiments, the comestible composition includes one or more fortification compounds. Such fortification compounds include, but are not limited to, vitamins, minerals, and iron salts. Non-limiting examples of vitamins include vitamins A, vitamin B complexes (including one or more of vitamin B-1, vitamin B-2, vitamin B-6, and vitamin B-12), vitamin C, vitamin D, vitamin E, vitamin K, niacin, and acid vitamins such as pantothenic acid, folic acid, and biotin. Non-limiting examples of minerals include calcium, iron, zinc, magnesium, iodine, copper, phosphorus, manganese, potassium, chromium, molybdenum, selenium, nickel, tin, silicon, and vanadium. In some embodiments, the mineral is an iron salt, such as ferric sodium EDTA, reduced iron, ferrous lactate, ferric citrate, ferric pyrophosphate, ferrous sulphate monohydrate, or ferric ammonium citrate brown. Specific amounts of fortification compounds will depend on a variety of factors such as the identity of other components of the comestible composition, and the like.

In some embodiments, the comestible composition comprises one or more fillers. In some embodiments, the filler is a carbohydrate. Suitable carbohydrates include, but are not limited to, starches, flours, sugars, maltodextrins, glucose syrups, or any combinations thereof. Such starches or flours include those from plants such as rice, wheat, corn, barley, and sorghum, potato, cassava, sweet potato, arrowroot, yam, pea, chickpea, mung bean, or lentil, or any combination thereof. When present, such fillers can have any suitable concentration in the comestible composition. For example, in some embodiments, the comestible composition comprises fillers at a concentration ranging from 0.1 percent by weight to 10 percent by weight, or from 0.5 percent by weight to 10 percent by weight, or from 1 percent by weight to 10 percent by weight, based on the total weight of the comestible composition.

The comestible compositions disclosed herein can, in certain embodiments, contain other additives, adjuvants, and the like, that are commonly included in food products, pet food products, and feed products. For example, the comestible compositions disclosed herein can, in certain embodiments, comprise any additional ingredients or combination of ingredients as are commonly used in comestible products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

### Lipid Particles

In some embodiments, the comestible composition comprises a plurality of lipid particles. These particles comprise (i) a non-animal fat, a non-animal free fatty acid, or a combination thereof, and (ii) and a flavor oil.

In some embodiments, the lipid particles comprise a non-animal fat. Any suitable non-animal fat can be used in the lipid particles, including fats derived from plants, fungi, algae, and any combinations thereof. In some embodiments, the non-animal fat is a plant-derived fat. In some embodiments, the non-animal fat comprises palm oil, palm kernel oil, coconut oil, cocoa butter, fractions of any of the foregoing, or any combinations thereof. As used herein, a “fraction” of an oil is a higher-melting portion of the oil that is separated from other components in the oil, for example, by crystallization. Palm stearin is a common example of such a fraction, which is obtained by the slow crystallization of palm oil and the separation of the higher-melting portion that crystallizes as heated oil is cooled to a temperature near its melting point. Other examples include shea stearin, rice stearin, and the like. Also, note that the term “oil” is used here with reference to these particular plant-based fat because that is the common term for referring to such fats, even though they are solids at 20° C. In some embodiments, the non-animal fat comprises palm oil or a fraction thereof, such as palm stearin. In some embodiments, the non-animal fat comprises coconut oil. In some In some embodiments, the non-animal fat comprises palm kernel oil. In some embodiments, the non-animal fat comprises cocoa butter. In general, the non-animal fat comprises mostly triglycerides. In some embodiments, a minor amount of monoglycerides and diglycerides can be present. For example, in some embodiments, the non-animal fat comprises at least 60% by weight, or at least 70% by weight, or at least 80% by weight, or at least 90% by weight, or at least 95% by weight, triglycerides, based on the total weight of glycerides in the plurality of lipid particles.

In some embodiments, the lipid particles comprise free fatty acids. In some such embodiments, the free fatty acids are derived from non-animal sources, such as plants, fungi, algae, or any combinations thereof. In some embodiments, the free fatty acids are derived from plants, such as palm, coconut, or cocoa. Non-limiting examples of free fatty acids suitable for use in the plurality of lipid particles include capric acid, lauric acid, myristic acid, palmitic acid, stearic acid, oleic acid, linoleic acid, linolenic acid, eicosapentaenoic acid, docosahexaenoic acid, or any combinations thereof. In some embodiments, the free fatty acid is palmitic acid.

In embodiments where a non-animal free fatty acid and a non-animal fat are present in the lipid particles, the weight ratio of non-animal fat to non-animal free fatty acid ranges from 1:10 to 10:1, or from 1:6 to 6:1, or from 1:3 to 3:1. In some embodiments, the lipid particles comprise non-animal fat and substantially no non-animal free fatty acid. For example, in some such embodiments, no more than 5% by weight, or no more than 3% by weight, or no more than 1% by weight of non-animal fatty acid is present in the lipid particles relative to the total amount of non-animal fat and non-animal free fatty acid. In some embodiments, the lipid particles comprise non-animal free fatty acid and substantially no non-animal fat. For example, in some such embodiments, no more than 5% by weight, or no more than 3% by weight, or no more than 1% by weight of non-animal fat is present in the lipid particles relative to the total amount of non-animal fat and non-animal free fatty acid.

In some embodiments, the lipid particles comprise a carrier, for example, a solid carrier. In certain embodiments, the lipid particles are prepared by methods such as spray drying or extrusion. In such cases, a solid carrier is present to facilitate the formation of the particles. Any suitable carrier material can be used, such as carrier materials commonly employed in the formation of comestible particles via spray drying or extrusion. In some embodiments, the solid carrier is water soluble. As used in this context, a carrier is “water soluble” if it forms a single-phase solution when dissolved in water at concentrations as high as 20 percent by weight. In some embodiments thereof, the water-soluble carrier forms a single-phase solution when dissolved in water at concentrations as high as 20 percent by weight, or as high as 40 percent by weight, or as high as 50 percent by weight. Some non-limiting examples of water-soluble carriers include: maltodextrin; inulin or chicory fiber; plant-based proteins, such as pea protein; water-soluble flours; gums, such as gum Arabic; soluble fibers; soluble polysaccharides; and combinations thereof.

Any suitable soluble fibers can be used, including, but not limited to, fruit fiber (such as citrus fiber), grain fibers, psyllium husk fiber, natural soluble fibers and synthetic soluble fibers. Natural fibers include soluble corn fiber, maltodextrin, acacia, and hydrolyzed guar gum. Synthetic soluble fibers include polydextrose, modified food starch, and the like. Non-limiting examples of food-grade sources of soluble fiber include inulin, corn fiber, barley fiber, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea), Danish potatoes, konjac vegetable fiber (glucomannan), psyllium fiber from seed husks of planago ovate, psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose. In some embodiments, the carrier comprises maltodextrin, gum Arabic, pea protein, inulin, or any combination thereof. In some embodiments, the carrier comprises maltodextrin. In some embodiments, the carrier comprises a modified starch, such as dextrin. In some embodiments, the carrier comprises a mixture of dextrin and maltodextrin.

In some embodiments, the carrier has emulsifying properties. Non-limiting examples include gum Arabic or pea protein. In some such embodiments, the lipid particle comprises substantially no emulsifier, for example, no more than 3 percent by weight, or no more than 2 percent by weight, or no more than 1 percent by weight, emulsifier, based on the total weight of the lipid particle.

The carrier can be present in any suitable amount in the lipid particles. In some embodiments, the carrier makes up from 2.5 percent by weight to 50 percent by weight, or from 5 percent by weight to 50 percent by weight, or from 10 percent by weight to 50 percent by weight, or from 15 percent by weight to 50 percent by weight, or from 25 percent by weight to 50 percent by weight, or from 30 percent by weight to 50 percent by weight, or from 30 percent by weight to 40 percent by weight, of the lipid particles, based on the total weight of the particles.

In some embodiments, the lipid particles comprise an emulsifier. As noted above, some carriers can serve simultaneously as an emulsifier, which can, among other things, assist in the process of forming the lipid particles by spray drying. In some embodiments, the emulsifier is a hydrophilic emulsifier, which, for example, can be suitable for spray drying an oil-in-water emulsion. Any suitable such emulsifier can be used. For example, polymeric emulsifiers and small molecule surfactants can be used. In some embodiments, the emulsifier is a plant-based protein, such as pea protein or rice protein, gum Arabic, modified food starch (for example, dextrin), Quillaja saponins, lecithin, or any combinations thereof.

The emulsifier can be present in any suitable amount in the lipid particles. In some embodiments, the carrier makes up from 1 percent by weight to 30 percent by weight, or from 2 percent by weight to 30 percent by weight, or from 5 percent by weight to 30 percent by weight, or from 8 percent by weight to 30 percent by weight, or from 8 percent by weight to 20 percent by weight, of the lipid particles, based on the total weight of the particles.

The lipid particles further comprise one or more flavor oils. The term “flavor oil” means a flavoring ingredient or a mixture of flavoring ingredients, solvents or adjuvants used or the preparation of a flavoring formulation, for example, a particular mixture of ingredients which is intended to be added to an edible composition (including but not limited to a beverage) or chewable product to impart, improve, or modify its organoleptic properties, in particular its flavor or taste. The flavor oil is a liquid at about 20° C. Flavoring ingredient is understood to include a variety of flavor materials of both natural and synthetic origins, including single compounds or mixtures. Many of these flavoring ingredients are listed in reference texts such as S. Arctander, PERFUME AND FLAVOUR CHEMICALS (1969), or its more recent versions, or in other works of similar nature such as FENAROLI'S HANDBOOK OF FLAVOUR INGREDIENTS (1975), or SYNTHETIC FOOD ADJUNCTS (1947). Solvents and adjuvants of current use for the preparation of a flavoring formulation are also well known in the industry. These substances are well known to the person skilled in the art of flavoring and/or aromatizing foods and consumer products.

The flavoring ingredient may be a taste modifier or a taste compound. Examples of taste compounds are salt, inorganic salts, organic acids, sugars, amino acids and their salts, ribonucleotides, and sources thereof. A “taste modifier” is understood as an active ingredient that operates on a human taste receptors, or provides a sensory characteristic related to mouthfeel (such as body, roundness, or mouth-coating) to a product being consumed. Non-limiting examples of taste modifiers include active ingredients that enhance, modify or impart saltiness, fattiness, umami, kokumi, heat sensation or cooling sensation, sweetness, acidity, tingling, bitterness or sourness.

In some embodiments, the flavoring oil comprises a beef flavor. In some embodiments, the flavoring oil comprises additional components that enhance or impart an umami taste, that enhance or impart a kokumi taste, or that mask or block a bitter taste.

The lipid particles can have any suitable physical properties, such as melting properties. In some embodiments, the lipid particles have a peak melting temperature greater than 20° C. and less than 70° C. In some embodiments, the lipid particles have a T_{50%} (temperature at which half by weight of the lipid particles have melted) of greater than 15° C. and less than 60° C. In some embodiments, the lipid particles have a T_{95%} (temperature at which 95% by weight of the lipid particles have melted) of greater than 20° C. and less than 80° C.

The lipid particles can have any suitable particle size. In some embodiments, the lipid particles have a minimum particle size of at least 10 μm, or at least 20 μm. In some embodiments, the lipid particles have an average particle size ranging from 50 μm to 750 μM, or from 50 μm to 500 μm.

The lipid particles can be formed by any suitable means, such as by spray drying or extrusion. Such methods are described in PCT Publication WO 2021/104846, which is hereby incorporated by reference as though set forth herein in its entirety.

### Water-In-Oil Emulsions

In some embodiments, the comestible composition comprises an emulsion, which comprises a continuous phase and a dispersed phase, wherein the continuous phase comprises a fatty composition, and the dispersed phase comprises an aqueous medium. In some embodiments, the aqueous medium comprises water and, optionally, one or more water-soluble flavor compounds, such as aroma compounds. In some such embodiments, the continuous phase makes up from 30 weight percent to 99 weight percent of the emulsion, and the dispersed phase makes up from 0.1 weight percent to 50 weight percent of the emulsion. In some embodiments, the fatty composition comprises solid fat particles and a liquid oil, wherein the solid fat particles are dispersed within the liquid (edible) oil. In some embodiments thereof, the fatty composition comprises an emulsifier. In some embodiments thereof, the fatty composition comprises one or more fat-soluble flavor compounds, fat-soluble aroma compounds, or combinations thereof. In some embodiments, the weight-to-weight ratio of liquid (edible) oil to solid fat particles ranges from 30:70 to 99:1. In some embodiments where an emulsifier is present, the emulsifier is present in a concentration ranging from 0.2 weight percent to 35 weight percent, based on the total weight of the fatty composition.

In some embodiments, the fat particles comprise plant-derived fats. Suitable such plant-derived fats include cocoa butter, palm fat (i.e., solid palm oil), coconut fat (i.e., solid coconut oil), palm kernel fat (i.e., solid palm kernel oil), hydrogenated vegetable oils, or any combinations thereof. In some embodiments, the plant-derived fats include cocoa butter. In some such embodiments, the fat particles comprise at least 75% by weight, or at least 80% by weight, or at least 85% by weight, or at least 90% by weight, or at least 95% by weight, or at least 97% by weight, or at least 99% by weight, of plant-derived fats, based on the total weight of solid fat particles in the fatty composition.

In some other embodiments, the fat particles comprise animal-derived fats. Suitable such animal derived fats include butter, lard, tallow, or any combination thereof. In some such embodiments, the fat particles comprise no more than 25% by weight, or no more than 20% by weight, or no more than 15% by weight, or no more than 10% by weight, or no more than 5% by weight, or no more than 3% by weight, or no more than 1% by weight, of animal-derived fats, based on the total weight of solid fat particles in the fatty composition.

In general, the fats that make up the solid fat particles are triglycerides, but may include certain amounts of diglycerides or monoglycerides. Note, as used herein, the term “fat” refers to fatty acid glycerides, which are in a solid state at a given temperature, such as room temperature (20° C.). The fats that make up the solid fat particles comprise at least 75% by weight, or at least 80% by weight, or at least 85% by weight, or at least 90% by weight, or at least 95% by weight, or at least 97% by weight, of triglycerides, based on the total weight of fatty acid glycerides in the solid fat particles. The fatty acids that make up the fatty acid glycerides in the solid fat particles can be any suitable mixture of saturated and unsaturated fatty acids. In some embodiments, the fats that make up the solid fatty particles have an iodine number ranging from 1 to 75, or from 2 to 65, or from 5 to 55.

The solid fat particles can have any suitable melting point. In some embodiments, the solid fat particles have a melting point of at least 30° C., or at least 35° C., or at least 40° C. In some further embodiments, the solid fat particles have a melting point of no more than 80° C.

In some embodiments, the solid fat particles comprise an edible wax. Non-limiting examples of edible waxes include hydrogenated soy fat, palm fat, coconut fat, cocoa butter, carnauba wax, rice bran wax, shea butter, and mixture thereof. In some embodiments, the edible wax is an animal fat having higher melting point fat fractions such as palm or shea olein and mixtures thereof.

As noted above, the fatty composition also comprises a liquid (edible) oil into which the solid fat particles are dispersed. Any suitable can be used, so long as the oil is generally a liquid at room temperature (e.g., 20° C.), such as an animal oil, a fish oil, a vegetable oil, an algal oil, or any combination thereof. In some embodiments, the liquid oil is a plant-derived oil. In some other embodiments, the oil is not a plant-derived oil. Examples of liquid oils include sunflower oil, rapeseed or canola oil, soybean oil, palm oil, coconut oil, groundnut (peanut) oil, palm kernel oil, olive oil, cottonseed oil, sesame oil, linseed oil, an algal oil, a marine oil, avocado oil, argan oil, and any mixtures thereof. In some embodiments, the liquid oil comprises medium chain triglyceride oil (MCT) oil, soybean oil, cottonseed oil, peanut oil, sesame oil, corn oil, sunflower oil, canola oil, safflower oil, avocado oil, olive oil, argan oil, or any mixtures thereof.

In general, the liquid oil and the solid fatty particles will have a difference in their melting point. In general, the liquid oil will have a melting point of no more than 25° C., or no more than 20° C., or no more than 15° C., or no more than 10° C., or no more than 8° C., or no more than 5° C.

In some embodiments, the difference in melting between the higher melting point of the solid fat particles and the lower melting points of the liquid oil ranges from 5° C. to 105° C., or from 8° C. to 90° C., or from 10° C. to 80° C., or from 12° C. to 70° C., or from 15° C. to 60° C.

The solid fat particles and the liquid oil can be present in the fatty composition in any suitable relative amounts, so long as there is enough liquid oil to disperse the solid fatty particles at around room temperature. In some embodiments, weight ratio of liquid oil to solid fat particles in the fatty composition ranges from 30:70 to 99:1, or from 40:60 to 98:2, or from 55:45 to 97:3, or from 60:40 to 95:5, or from 70:30 to 93:7, or from 72:28 to 92:8.

In some embodiments, it may be desirable that the fatty composition be substantially free of animal fats or oils. Thus, in some embodiments, the fatty composition comprises no more than 5% by weight, or no more than 3% by weight, or no more than 1% by weight, or no more than 0.5% by weight, or no more than 0.3% by weight, or no more than 0.1% by weight, of animal-derived fats or oils, based on the total weight of the fatty composition.

In some embodiments, it may be desirable that the fatty composition be substantially free of fats or oils derived from genetically modified plants (GMO-derived fats or oils).

Thus, in some embodiments, the fatty composition comprises no more than 5% by weight, or no more than 3% by weight, or no more than 1% by weight, or no more than 0.5% by weight, or no more than 0.3% by weight, or no more than 0.1% by weight, of GMO-derived fats or oils, based on the total weight of the fatty composition.

In some embodiments, the fatty composition comprises an emulsifier. When present, the emulsifier can be present at any suitable concentration. In some embodiments, the concentration of emulsifier in the fatty composition ranges from 0.2% by weight to 35% by weight, or from 0.3% by weight to 20% by weight, or from 0.4% by weight to 15% by weight, or from 0.5% by weight to 10% by weight, or from 0.6% by weight to 8% by weight, of emulsifier, based on the total weight of the fatty composition.

In general, emulsifiers are amphiphilic molecules that concentrate at the interface between two phases and modify the properties of that interface. Suitable non-limiting examples of emulsifiers are described in MCCUTCHEON'S EMULSIFIERS & DETERGENTS OR THE INDUSTRIAL SURFACTANTS HANDBOOK. Some specific non-limiting examples of emulsifiers include lecithins, polyoxyethene, stearates, polysorbate 20, sorbitan derivatives (polysorbate 20, polysorbate 80, polysorbate 40, polysorbate 60, and polysorbate 65), mixed ammonium salts of phosphorylated glycerides, enzymatically hydrolyzed carboxymethyl-cellulose, mono- and diglycerides of fatty acids, esters of mono- and diglycerides of fatty acids (such as acetic acid esters, lactic acid esters, citric acid esters, tartaric acid esters, mono- and diacetyl tartaric acid esters, mixed acetic and tartaric acid esters), succinylated monoglycerides, sucrose esters of fatty acids, sucroglycerides, polyglycerol esters of fatty acids, polyglycerol polyricinoleate, propane-1,2-diol esters of fatty acids, propylene glycol esters of fatty acids, lactylated fatty acid esters of glycerol and propanol, thermally oxidized soya bean oil interacted with mono- and diglycerides of fatty acids, sodium stearoyl lactylate, calcium stearoyl lactylate, stearyl tartrate, stearyl citrate, sodium stearoyl fumarate, calcium stearoyl fumarate, sodium dodecyl sulfate, ethoxylated mono- and di-glycerides, methyl glucoside-coconut oil ester, sorbitan monostearate, sorbitan tristearate, sorbitan monolaurate, sorbitan monooleate, sorbitan monopalmitate, sorbitan trioleate, and combinations thereof.

In some embodiments, the emulsifier comprises lecithins (such as mixtures of glycerophospholipids, including phosphatidylcholine PC, phosphatidylethanolamine PE, phosphatidylinositol PI, and phosphatidic acid PA) with different triglyceride content (pure lecithins or deoiled lecithins, different ratio PC-to-PE-to-PI). Such lecithins can be used in any suitable form, including in the form of oily paste or powders. Lecithins are commercially available from a number of suppliers including Cargill (brands EMELPUR, EMULTOP, LECIMULTHIN, EPIKURON), Archer Daniels Midland (brand ULTRALEC, ADLEC), Solae (brand SOLEC), and Bunge (brand BUNGEMAXX).

Suitable emulsifiers can be characterized according to their hydrophilic-lipophilic balance (HLB), measured on an empirical scale set forth in Griffin, J. COSMET. CHEM., vol. 1, p. 311 (1949). This scale ranges from 0 to 20, with 0 for a completely lipophilic molecule and 20 for a completely hydrophilic molecule. The function of surfactants can be generally described by their HLB number. Defoaming surfactants have an HLB range of 1-3. Water-in-oil emulsifiers have an HLB range of 3-6. Wetting agents have an HLB range of 7-9. Oil-in-water emulsifiers have an HLB range of 8-18. Detergents have an HLB range of 13-15. Solubilizers have an HLB range of 15-18.

In some embodiments, the emulsifier present in the fatty composition has an HLB value of no more than 10, of no more than 9, or of no more than 8, or of no more than 7, or of no more than 6. In some embodiments, the emulsifier present in the fatty composition has an HLB value ranging from 3 to 9, or from 4 to 9, or from 5 to 9, or from 6 to 9, or from 7 to 9, or from 3 to 8, or from 3 to 7, or from 3 to 6. Such emulsifiers may be referred to as low-HLB emulsifiers.

Non-limiting examples of the low-HLB emulsifiers suitable to form water-in-oil emulsion include, alcohol alkoxylates, alkylamine alkoxylates, polyetheramine alkoxylates, ethylene oxide/propylene oxide block polymers, phosphate esters, alkyl sulfates, alkyl ether sulfates, alkyl and alkylbenzene sulfonates, fatty acid esters, fatty oil alkoxylates, saccharide derivatives, sorbitan derivatives, alkyl phenol alkoxylates, arylphenol alkoxylates, sulphosuccinates, sulphosuccinamates, and any combinations thereof. The emulsifiers can be nonionic, anionic, cationic or zwitterionic. In some embodiments, the emulsifiers are suitable for use in foods, pet foods, or feed products, including, but not limited to fatty acid esters, saccharide derivatives, sorbitan derivatives, especially sorbitan esters, mono/diglyceride, citric acid esters, lecithin and other phospholipids, and combinations thereof. Commercial examples of such low-HLB emulsifiers include, but are not limited to, the DIMODAN emulsifiers (distilled monoglycerides) available from DuPont-Danisco, CITREM (citric acid esters of mono- and diglycerides) available from Paalsgard, SOLEC (soy lecithin) available from DuPont Nutrition, or GRINSTED STS/SMS (sorbitan esters) also available from DuPont Nutrition.

In some embodiments thereof, the fatty composition comprises fat-soluble flavor compounds, such as fat-soluble aroma compounds. Such fat-soluble flavor compounds can be present in the fatty composition in any suitable amount. For example, in some embodiments, the fat-soluble flavor compounds make up from 0.1% by weight to 80% by weight, or from 1% by weight or from 60% by weight, of the fatty composition, based on the total weight of the fatty composition.

Any suitable fat-soluble flavor compounds can be used, according to those known in the relevant art. Flavor compounds are discussed in further detail below.

As noted above, the fatty compositions are typically included in an water-in-oil emulsion, such that the continuous phase comprises the fatty composition and the dispersed phase comprises the aqueous medium. The fatty composition can have any suitable characteristics, according to the embodiments set forth in the preceding section of this disclosure. The aqueous medium comprises water. For example, in some embodiments, water makes up at least 75% by weight, or at least 80% by weight, or at least 85% by weight, or at least 90% by weight, or at least 95% by weight, or at least 97% by weight, or at least 99% by weight, of the aqueous medium, based on the total weight of aqueous medium. In some further embodiments, the aqueous medium comprises water-soluble flavor compounds.

As used herein, the term “emulsion” refers to a mixture of two or more liquids that are normally immiscible (i.e., not mixable). In an emulsion, one liquid (the dispersed phase) is dispersed in the other (the continuous phase). In certain instances, one of the phases is a hydrophobic or lipophilic phase, and the other phase is a hydrophilic phase. In certain embodiments disclosed herein, the emulsion is a water-in oil emulsions, which comprises a continuous hydrophobic (i.e., lipophilic) phase in which the hydrophilic phase is dispersed.

The emulsion can be any type of emulsion. For example, in some embodiments, the emulsion is a macroemulsion, a microemulsion, or a nanoemulsion.

The emulsions disclosed herein may be prepared by any suitable procedure. For example, in some embodiments, the emulsion is prepared by applying mechanical force to emulsify the disperse phase droplets, such as by mechanical mixing with a high shear blender, a colloidal mill, an impeller mixer, or by the use of a high-pressure homogenizer. In some embodiments, such emulsions are prepared by ultrasound processing, by phase inversion emulsification, by membrane emulsification, or by emulsification using microfluidic channels.

The emulsion can have any suitable weight ratio between the continuous phase and the dispersed phase. For example, in some embodiments, the continuous phase makes up from 30% by weight to 99% by weight, or from 35% by weight to 98% by weight; or from 38% by weight to 97% by weight, or from 40% by weight to 95% by weight, or from 45% by weight to 93% by weight, of the emulsion, based on the total weight of the emulsion. In certain related embodiments, the dispersed phase makes up from 0.1% by weight to 50% by weight, or from 3% by weight to 45% by weight, or from 5% by weight to 40% by weight, or from 8% by weight to 30% by weight, of the emulsion, based on the total weight of the emulsion.

In some embodiments, the aqueous medium comprises soluble fiber. In such embodiments, the soluble fiber can be present in any suitable concentration. For example, in some embodiments, the soluble fiber is present in the aqueous medium at a concentration ranging from 0.1% by weight to 5% by weight, or from 1% by weight to 2% by weight, based on the total weight of the aqueous medium. In some embodiments, the soluble fiber is present at a concentration suitable for forming a hydrogel when the emulsion is heated above room temperatures, such as standard temperatures for cooking meat.

As used herein, the term “soluble fiber” refers to polysaccharides that are soluble in water, such as according to the method set forth in Prosky et al, J. Assoc. ANAL. CHEM., vol. 70(5), p. 1017 (1988). Such fibers can include fibers from a variety of sources. Some non-limiting examples of suitable fibers include fruit fiber, grain fiber, natural soluble fiber, and synthetic soluble fiber. Natural soluble fiber includes soluble corn fiber, maltodextrin, acacia, and hydrolyzed guar gum. Synthetic soluble fibers include polydextrose, modified food starch, and the like. Food grade sources of soluble fiber useful in embodiments of the present disclosure include inulin, corn fiber, barley, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea), Danish potato fiber, konjac vegetable fiber, psyllium fiber (e.g., from seed husks of planago ovate), psyllium husk fiber, liquid agave fiber, rice bran fiber, oat sprout fibers, amaranth sprout fiber, lentil flour fiber, grape seed fiber, apple fiber, blueberry fiber, cranberry fiber, fig fiber, ciranda power fiber, carob powder fiber, milled prune fiber, mango fiber, orange fiber, orange pulp, strawberry fiber, carrageenan hydrocolloid, derivatives of eucheuma cottonnil seaweed, cottonseed fiber, soya fiber, kiwi fiber, acacia gum fiber, bamboo fiber, chia fiber, potato fiber, potato starch, pectin (carbohydrate) fiber, hydrolyzed guar gum, carrot fiber, soy fiber, chicory root fiber, oat fiber, wheat fiber, tomato fiber, polydextrose fiber, refined corn starch syrup, isomalto-oligosaccharide mixtures, soluble dextrin, mixtures of citrus bioflavonoids, cell-wall broken nutritional yeast, lipophilic fibers, prune juice, derivatives from larch trees, olygose fiber, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose.

In some embodiments, the aqueous medium comprises water-soluble flavor compounds. Any suitable water-soluble flavor compounds can be used, according to those known in the relevant art. Flavor compounds are discussed in further detail below.

In some cases, it may be desirable to describe the resulting emulsion in terms of particular physical characteristics. For example, in some embodiments, the emulsion is a water-in-oil emulsion having an elastic shear modulus G′ (0.3%, 0.5 Hz) higher than its viscous shear modulus G″ (0.3%, 0.5 Hz). Using this notation, the numbers provided in brackets refer to the strain amplitude given in percent values, and the frequency of the oscillatory shearing, meaning that values given refer to the shear modulus measured using shear oscillations performed at a frequency of 0.5 Hz and a strain amplitude of 0.3%. The elastic shear modulus represents the elastic behavior of a material for a given frequency and strain amplitude, and is conventionally written as G′ and measured in units of Pascal (Pa).

The viscous shear modulus represents the viscous behavior of a material for a given frequency and strain amplitude, and is conventionally written as G″ and also measured in units of Pascal (Pa). These characteristic values are, for example, defined in R. G. Larson, THE STRUCTURE AND RHEOLOGY COMPLEX FLUIDS (1998) or F. A. Morrison, UNDERSTANDING RHEOLOGY (2001).

These viscoelastic properties are measured during dynamic tests under oscillating shear strains (small deformations) performed at a constant temperature or between range of temperatures, for example at temperatures ranging from 4° C. to 80° C., and at a constant frequency (i.e., 0.5 Hz) or a frequency range on a rheometer (for example, a Model DHR-2, TA Instruments) under a torsional/shear strain (i.e., a sinusoidally varying shear strain with a strain amplitude of 0.3% and a frequency of 0.5 Hz), or a range of torsional/shear strains, for example testing a range of oscillatory shear strains with amplitudes ranging from 0.1% to 100%, for example, in cone-plate geometry (for example with a 40 mm diameter cone/plate geometry and a 2 degree cone angle). Such methods are further described in P. Fischer et al., “Rheology of Food Materials”, in CURRENT OPINION IN COLLOID & INTERFACE SCIENCE, vol. 16(1), pp. 36-40 (2011). For example, G′ (0.3%, 0.5 Hz) is the elastic shear modulus of a material, measured at a frequency of 0.5 Hz and at a torsional/shear stress of 0.3%, for a temperature from 5° C. to 80° C. G′ (18° C., 0.5 Hz) is the elastic shear modulus of a material, measured at a frequency of 0.5 Hz and at a temperature of 18° C., for any torsional/shear stress from 0.1% to 100%. G″ (0.3%, 0.5 Hz) is the viscous shear modulus of a material, measured at a frequency of 0.5 Hz and at a torsional/shear stress of 0.3%, for any temperature from 5° C. to 80° C.

In some embodiments, the emulsions disclosed herein have an elastic shear modulus G′ (0.5 Hz, 37° C.) higher than the viscous shear modulus G″ (0.5 Hz, 37° C.) at a shear strain lower than 8%, or lower than 7%, or lower than 5%. In some embodiments, the emulsions disclosed herein have a ratio G′ (0.3%, 0.5 Hz)/G′ (0.3%, 0.5 Hz) of no more than 20, or no more than 15, or no more than 10, or no more than 5, or no more than 3, or no more than 2, or no more than 1, or no more than 0.5. In some embodiments, the emulsions disclosed herein have a ratio G′ (0.3%, 0.5 Hz)/G′ (0.3%, 0.5 Hz) of at least 0.001, or at least 0.01, or at least 0.05. In some embodiments, the emulsions disclosed herein have a ratio G′/G″ (0.5 Hz, 18° C.) of no more than 1. In some embodiments, the emulsions disclosed herein have a ratio G′/G″ (0.5 Hz, 18° C.) of at least 0.01.

The dispersed phase generally forms drops in the emulsion. The drop size can be any suitable size, depending on various factors. In some embodiments, the emulsions have a drop size having an average diameter of ranging from 0.1 μm to 30 μm, or from 0.8 μm to 20 μm, or from 2 μm to 10 μm. The drop size can be measured via any well-established method that allows measurements which are accurate within an experimental error of 5% at the most and preferably below 1%. Suitable well-established methods use light microscopy (for example, R. J. Hunter, INTRODUCTION TO MODERN COLLOID SCIENCE (1994)). In some instances, the drop size distribution can be measured by image analysis using the software of the light microscope (Nikon Eclipse Software) of a sample diluted in heated isopropyl myristate. The term “average” refers to an arithmetic mean.

Further features of such emulsions and their method of preparation are set forth in PCT Publication No. WO 2020/260628, which is hereby incorporated by reference.

### Extrusion

The methods provided in this disclosure and the products formed from those methods include extruding a comestible composition to form an extruded comestible article.

The term “extrusion,” or its variants, refers to a process used to create objects of a fixed cross-sectional profile. A comestible composition is pushed or pulled through a die of a desired cross-section. The advantages of this process over other manufacturing processes are its ability to create very complex cross-sections and to prepare products that are brittle because the material only encounters compressive and shear stresses. High-moisture extrusion is known as wet extrusion.

In general, extruders comprise an extruder barrel within which a close-fitting screw rotates. The screw is made up of screw elements, some of which are helical screw threads to move material through the extruder barrel. The comestible composition is introduced into the extruder barrel toward one end, moved along the extruder barrel by the action of the screw and is forced out of the extruder barrel through a nozzle or die at the other end. The rotating screw mixes and works the material in the barrel and compresses it to force it through the die or nozzle. The degree of mixing and work to which the material is subjected, the speed of movement of the material through the extruder barrel and thus the residence time in the extruder barrel and the pressure developed in the extruder barrel can be controlled by the pitch of the screw thread elements, the speed of rotation of the screw and the rate of introduction of material into the extruder barrel.

The total length of an extrusion process can be defined by its modular extrusion barrel length. An extruder barrel is described by its unit of diameter.

In some embodiments, the extruder barrel comprises multiple extruder barrel sections which are joined end to end. Multiple extruder barrel sections may be required to carry out different processes involved in extrusion such as conveying, kneading, mixing, devolatilizing, metering, and the like. Each extruder barrel section comprises a liner which is press fit into an extruder barrel casing, and heating and cooling elements are provided to regulate temperature of extruder barrel section within permissible range.

In some embodiments, the extrudate (the comestible composition subjected to extrusion) is subjected to constriction. The term “constriction” refers to the temporary reduction of the cross-sectional area of the barrel. When employed, this has an influence on the laminar flow of the extrudate. By subjecting the extrudate to constriction, a turbulent flow is generated, which influences fiber alignment in the extrudate. In most cases, the obtained product is less dense, having a more meat-like fibrous structure compared to a standard extrusion process without a constriction. A less dense extrudate can be more easily injected with an aqueous solution and can improve the uptake of flavor compounds introduced following extrusion. The constrictor is made of metal or a heat-stable plastic material and can have any suitable geometry. In some embodiments, the constrictor provides a side constriction or a centered constriction. In this context, the term “temporary” means that before and after the constrictor the cross-sectional area of the barrel is larger.

In some embodiments, the constrictor is a perforated aperture, a stud, a ripple, a slit, a breaker plate or a combination thereof. In some embodiments, the constrictor is situated after the last extruder barrel, preferably between the last extruder barrel and a first half of the length of the cooling die, such as between the last extruder barrel and a first third length of a cooling die. In some embodiments, the constrictor is located after the last extrusion barrel.

The comestible composition can have any suitable viscosity when subjected to extrusion. For example, in some embodiments, the comestible composition has a viscosity ranging from 100 Pa·s to 10000 Pa·s, or from 100 Pa·s to 5000 Pa·s, or from 100 Pa·s to 4000 Pa·s, or from 100 Pa·s to 3000 Pa·s.

The extrudate can have any suitable moisture content. For example, in some embodiments, the extrudate has a low moisture content, such as a moisture content of no more than 20% by weight, or no more than 30% by weight, or no more than 40% by weight, or no more than 50% by weight. In some such embodiments, such low-moisture extrudates comprise at least 1% by weight moisture, or at least 5% by weight moisture, or at least 10% by weight moisture. In some other embodiments, the extrudate has a high moisture content, such as a moisture content of at least 40% by weight, or at least 50% by weight. In some such embodiments, such high-moisture extrudates comprise no more than 90% by weight moisture, or no more than 95% by weight moisture, or no more than 99% by weight moisture.

In some embodiments, the extruding comprises passing the extrudate through a cooling die. A “cooling die” is tube or die used to cool the extruded product to a desired temperature, and is situated after the extruder barrels and, if present, any constrictors. The cooling die can be either a static or dynamic die. In some embodiments, the extrusion is carried out in the absence of a cooling dye. For example, in some embodiments, the extrudate is a high-moisture extrudate and the extrusion is carried out in the absence of a cooling dye. Such processes can result in a resulting extruded product having a cheese-like consistency, thereby making such compositions suitable for use in cheese analogue applications.

The comestible composition can be prepared for extrusion in any suitable way. In a some embodiments, water is mixed with the other components of the comestible composition to form a thick slurry suitable for use with an extruder before feeding the comestible composition into the extruder barrels through a slurry inlet. In some such embodiments, the comestible composition is transferred (for example, by pumping) from a mixing apparatus to the inlet of the extruder. In some embodiments, the comestible composition is transferred directly from a mixing apparatus to the extruder barrel without any other processing or addition or removal of ingredients. In some other embodiments, the other ingredients are introduced to the extruder barrel in substantially dry form and water is added separately to the extruder barrel. In that case, the mixing of the dry ingredients and the water is carried out within the extruder barrel through mechanical force.

In general, the extruder barrels are maintained at an elevated temperature. For example, in some embodiments, the extruder barrels are heated to a temperature ranging from 30° C. to 200° C., or from 40° to 150° C.

Any suitable pressure and screw speed can be used to force the comestible composition through the extruder. For example, in some embodiments, the pressure on the front plate (between the final extruder barrel and the cooling die) ranges from 10 bar to 40 bar. In some embodiments, the screw speed ranges from 50 rpm to 600 rpm. In general, as the comestible composition is cooled while passing through the cooling die, the pressure is also gradually reduced. In some embodiments, for example, the extruded comestible composition has an exit temperature at the end of the cooling die ranging from 40° C. to 110° C.

Any suitable extruder can be used to carry out the extrusion step, such as any suitable static or dynamic extruder. Non-limiting examples include piston extruders, roller-type extruders, and screw extruders (such as single-screw extruders or twin-screw extruders). Further, the extruders can have any suitable heating or cooling mechanism. Thus, the extruder can be an extruder configured to carry out cold extrusion, hot extrusion, steam-induced extrusion, or co-extrusion, as well as wet extrusion or high-moisture extrusion cooking. In some embodiments, the extruder is a co-rotating twin screw extruder. In some embodiments, the extruder is a conical-type extruder, for example, using shear cell technology, such as that illustrated in Cornet et al., CRIT. REV. FOOD SCI. NUTR., vol. 62, issue 12, pp. 3264-3280 (2022), which is incorporated herein by reference. In some embodiments, the extruder is a single-screw extruder, for example, for texturized vegetable protein, using either a static or dynamic die. In some embodiments, the extruder is an extruder suitable for high-moisture extrusion, for example, with a long-cooling static or dynamic die. Examples of suitable means of making texturized vegetable protein are set forth in PCT Publication No. WO 2016/118479. Examples of suitable extruders include extruders from the POWERHEATER line of extruders (PreciPak, Mundelein, Illinois, US). Other suitable extrusion methods and apparatuses are set forth in Snel et al., INNOVATIVE FOOD SCI. EMERGING TECHS., vol. 81, article 103152 (2022). Other suitable extrusion methods and apparatuses are set forth in PCT Publication No. WO 2022/018084.

### Cutting

The methods disclosed herein include cutting the extruded composition. In some aspects, the cutting is performed after a post-extrusion introduction of a flavor composition. In such cases, the flavoring composition is introduced to the extruded comestible composition using any suitable method, such as injecting, spraying, and the like. Such techniques are well known in the art. In some other aspects, the cutting is performed before a post-extrusion introduction of a flavoring composition. In such cases, the flavoring composition can be introduced in any suitable way, such as marinating, injecting, spraying, and the like. Such techniques are well known in the art.

The term “cutting” refers broadly to the use of slicing, chopping, grinding, shredding, grating, or a combination thereof. The cutting can be carried out by any suitable means, including, but not limited to, using static, rotating, or vibrating knives having vertical, horizontal, or diagonal knives, depending on the shape of the flavored product to be manufactured.

### Flavoring Composition and its Introduction

The methods disclosed herein include introducing a flavored composition. This can occur before the cutting, after the cutting, or before and after the cutting. In general, the flavored composition comprises water. In some embodiments, the flavored composition comprises one or more lipid materials as well, for example, as an oil-in-water or a water-in-oil emulsion. In some embodiments, the flavoring composition comprises water at a concentration ranging from 5 percent by weight to 99 percent by weight, or from 5 percent by weight to 90 percent by weight, or from 5 percent by weight to 80 percent by weight, or from 5 percent by weight to 70 percent by weight, based on the total weight of the flavoring composition. Note that, in some embodiments, one or more flavorings are introduced prior to extrusion as well.

### Flavoring and Other Ingredients

In general, the flavoring composition comprises one or more flavorings. The flavorings can include any flavorings, including volatile compounds, non-volatile compounds, and aroma compounds. In some embodiments, the flavoring composition comprises any of the flavorings described above as a component of the comestible composition. In some embodiments, the flavoring comprises one or more iron-based compounds, such as any compounds set forth in PCT Publication No. WO 2015/153666.

Volatile flavor compounds are well known to those of skill in the art. Such compounds include various carboxylic acids, aldehydes, ketones, alcohols, esters, and hydrocarbons. Specific examples include, but are not limited to, acetaldehyde, 3-methyl-butanal, hexanal, heptanal, nonanal, (E)-2-pentenal, (E)-2-octenal, (E)-2-nonenal, 2,3-butanedione, acetoin, 2-heptanone, 2-nonanone, formic acid ethenyl ester, acetic acid, propionic acid, ethyl dimethyl pyrazine, nonanone, diallyl sulfide, diallyl disulfide, diallyl trisulfide, 2-methyl-2-butenal, (Z)-3-hexenal, 2-methyl-2-pentenal, mercaptobutanone, methional, 3,4-dimethylthiophene, methylfuranthiol, phenylacetaldehyde, 2-pentylfuran, 2,4-decadienal, and 2,4-undecadienal. In some embodiments, the flavoring composition comprises meat or grilled meat flavorings, such as diketopiperazines and other known Maillard reaction products. In some embodiments, the flavoring that provides a cheese tonality, including flavorings of cheddar cheese, Emmental cheese (Swiss cheese), mozzarella cheese, Parmesan cheese, and the like.

The flavoring can be present in the flavoring composition in any suitable concentration. In some embodiments, the concentration of the one or more flavorings in the flavoring composition ranges from 0.1 to 40 percent by weight, or from 0.1 to 30 percent by weight.

In some embodiments, the flavoring composition also comprises one or more of hydrocolloids, starches, proteins, dietary fibers, vitamins, minerals, colorants, lipids, or any combination thereof. The flavoring composition can have any suitable viscosity. For example, in some embodiments, the flavoring composition has a viscosity ranging from 1 Pa·s to 10 Pa·s at a shear rate of 1 s⁻¹ at 25° C. When present, various other components of the flavoring composition can be present in concentration ranges as follows: 0.01-10 percent by weight hydrocolloid; 0.0001-5 percent by weight vitamins, 0.0001-5 percent by weight minerals, 0.01-10 percent by weight colorant; 0.1-7 percent by weight starch; 0.01-5 percent by weight proteins; 0.01-5 percent by weight dietary fiber; 0.01-30 percent by weight lipids.

Any suitable hydrocolloid can be used. Suitable examples include, but are not limited to, xanthan, locust bean gum, guar gum, gellan, konjac gum, agar gum, alginate, pectin, carrageenan or a combination thereof.

Any suitable starches can be used. Suitable examples include, but are not limited to, starches from rice, wheat, corn, barley, and sorghum, potato, cassava, sweet potato, arrowroot, yam, pea, chickpea, mung beans or lentil, or any combination thereof.

Any suitable proteins can be used. Suitable examples include, but are not limited to, the plant proteins set forth above in connection with the comestible composition.

Any suitable fiber can be used. For example, in some embodiments, the fibers are fibers from vegetables, fruits, cereal, pulses or combinations thereof, such as fiber from carrot, beetroot, pumpkin, citrus, wheat, oat, bamboo, tomato, bell pepper, leek, ginger, onion, kale, parsnip, celery, cucumber, courgette, broccoli, kohlrabi, asparagus, bean, fava bean, lentil, chickpea, peas, lupin, vetches, psyllium or combinations thereof.

### Introducing Flavoring Composition to Extruded Comestible Composition

The methods disclosed herein include introducing the flavoring composition to the extruded comestible composition. In some embodiments, this occurs before the cutting. In such cases, the flavoring composition is introduced to the comestible composition via nozzles, injectors, apertures, and the like, where the flavoring composition is injected into, sprayed onto, or mixed into the comestible composition. In some other embodiments, the flavoring is introduced by dry mixing. In some other embodiments, introducing the flavoring composition to the extruded comestible composition occurs after the cutting. In such other embodiments, the flavoring composition can be introduced in any suitable way, such as spraying, dipping, marinating, and the like.

### Flavored Products; Meat Analogues

In certain aspects, the disclosure provides a flavored product, which is formed by the method of the foregoing aspects, or any embodiments thereof. In some embodiments, the flavored product is a food product, such as a meat analogue product, for example, a non-animal-based ground beef replica. In some embodiments, the flavored product is an analogue of other meats, such as beef (such as a vegan beef kebab), chicken, (such as a vegan chicken nugget, strip, kebab, or breast filet), turkey, duck, goose, pheasant, frog, rabbit, squirrel, lamb (such as a vegan lamp kebab), ostrich, bison, and pork (such as vegan pulled pork, bacon, sausages, and hot dogs). In some other embodiments, the flavored product is an animal feed product, such as pet food product. In some embodiments, the flavored product is a seafood analogue product, such as an analogue of shrimp, squid, scallop, oyster, mussels, fish, and the like. In other embodiments, the flavored products contain no animal-based products.

In some embodiments, the flavored product is a cheese analogue product, for example, a non-animal-based cheese replica. Such flavored products can be designed to simulate cheese products, such as sliced cheese, block cheese, spray cheese, cheese spreads, cream cheese, and the like.

In some other embodiments, the flavored product is a meat-replacement product (or meat analogue), such as a product designed to mimic products traditionally made from red meat. For example, the flavored product can be a meat dough, such as those described in PCT Publication No. WO 2015/153666. Such flavored products can be designed to simulate beef products, such as ground beef (for making burgers) or cuts of beef for inclusion in soups, prepared meals, and the like. The flavored products can also be designed to simulate cuts or ground forms of other red meat, such as pork, goat, lamb, venison, and bison.

### EXAMPLES

To further illustrate the inventions disclosed herein, the following examples are included. The examples should not, of course, be construed as specifically limiting the invention. Variations of these examples within the scope of the claims are within the purview of one skilled in the art and are considered to fall within the scope of the invention as described and claimed herein. The reader will recognize that the skilled artisan, armed with the present disclosure, and skill in the art is able to prepare and use the invention without exhaustive examples.

The following examples refer to Dynarome SR and Dynarome TR (which were sourced from Firmenich SA, Satigny, Switzerland). These materials were used to reduce the fat content of certain meat analogue products. Dynarome SR is a water-in-oil emulsion, according to Example 6 of PCT Publication No. WO 2020/260628, which is incorporated herein by reference. Dynarome TR is a composition that consists of spray-dried lipid particles, according to Sample E of Example 2 of PCT Publication No. WO 2021/104846, which is also incorporated herein by reference. Thus, Dynarome SR is an embodiment of the water-in-oil emulsions described above, and Dynarome TR is an embodiment of the lipid particles described above.

### Example 1: Headspace Analysis

For each of a series of volatile flavor compounds, four (4) samples were prepared. In each case, the base composition contained pea protein isolate (30 wt %) and water (70 wt %). For the control sample (Sample C1), a flavoring composition was added to the base composition, and then extrusion was performed using s static-dye extruder on the composition. For Sample S1, the flavoring composition was added to the base composition after extrusion via marination, such that the concentration of the volatile flavor compound is introduced at approximately the same concentration as in Sample Cl. For Sample S2, the sample was prepared in the same way as Sample S1, except that Dynarome SR was added to the comestible composition at standard concentrations. For Sample S3, the sample was prepared in the same way as Sample S1, except that Dynarome TR was added to the comestible composition at standard concentrations. All samples were blended with water to make a dispersion, and static headspace analysis was carried out for each of the four samples shortly after blending. Table 1 shows the results of the static headspace analysis for each of the four (4) samples for each volatile flavor compound. The values for static headspace analysis are reported in terms of total signal intensity.

TABLE 1

| Ingredient | C1 | S1 | S2 | S3 |
|---|---|---|---|---|
| Propionic Acid | 12 | 865 | 26 | 17 |
| 5-Ethyl-2,3-dimethylpyrazine | 23 | 54 | 54 | 51 |
| 2-Nonanone | 60 | 756 | 840 | 868 |
| Diallyl disulfide | 0.4 | 14 | 11 | 11 |

### Example 2: Extruded Cheese Analogue Product

The ingredients were dry blended with protein concentrate or isolate powders and fed through a gravimetric feeder. Water was injected at the first zone (Z1) and extruded under the following conditions:
Temp (° C.) (Z1, Z2, Z3, and Z4): 40, 80, 105, and 105
RPM: 400
Melt Temp (° C.): 95-100
Round die head with 8 mm diameter.
   The final moisture content in extrudate was 60%, indicating that the process can be classified as High Moisture Extrusion (HME) but with slightly deviated from Standard HME process. In a standard HME process, there is an extended cooling die after the extruder barrel which helps in fibrilization of the molten protein matrix. In this instance, a cooling die was not used. At the end, a doughy kind of string having a texture resembling Cheese was obtained. Further, Dynarome SR was used at up to 1.5 weight percent without negatively affecting overall process. Four samples were prepared—one control and three test samples. Table 2 sets forth the contents of each of these samples, labeled C2, S4, S5, and S6. Amounts are given in weight percent, based on the total weight of the composition.

TABLE 2

| | C2 | S4 | S5 | S6 |
|---|---|---|---|---|
| Pea protein concentrate | 9.1 | 9.1 | 7.6 | 7.6 |
| Fava protein concentrate | 10.0 | 10.0 | 10.0 | 10.0 |
| Pea protein isolate | 20.9 | 15.0 | 15.0 | 15.0 |
| Water | 60.0 | 60.0 | 60.0 | 60.0 |
| Corn soluble fiber | — | 2.3 | 2.3 | 2.3 |
| Potato fiber | — | 0.2 | 0.2 | 0.2 |
| Pea fiber | — | 0.1 | 0.1 | 0.1 |
| Flavorings | — | 2.4 | 2.4 | 2.4 |
| Sodium chloride | — | 0.4 | 0.4 | 0.4 |
| Gellan gum | — | 0.5 | 0.5 | 0.5 |
| Dynarome SR | — | — | 1.5 | — |
| Sunflower oil | — | — | — | 1.5 |

The four samples C2, D4, S5, and S6 were subjected to sensory testing, wherein approximately 10 trained panelists evaluated the four samples on a number of different sensory criteria. Each sensory criterion was evaluated on a scale from 0 to 10, with a higher number indicating greater intensity of the characteristic measured. The numbers reported in Table 3 reflect the mean of the sample evaluations of the panelists.

TABLE 3

| | C2 | S4 | S5 | S6 |
|---|---|---|---|---|
| Green vegetal flavor | 5.4 | 3.6 | 2.2 | 2.9 |
| Cheese flavor (aroma) | 0.2 | 3.4 | 3.7 | 3.8 |
| Cheese flavor (taste) | 0.3 | 3.2 | 3.9 | 3.3 |
| Lingering cheese flavor | 0.4 | 2.7 | 3.3 | 3.0 |
| Buttery cheese flavor | 0.2 | 2.6 | 3.6 | 3.0 |
| Sweetness | 0.3 | 2.1 | 1.9 | 1.6 |
| Bitterness | 3.0 | 2.2 | 1.8 | 2.2 |
| Fattiness | 0.8 | 1.9 | 2.0 | 2.1 |
| Pungency | 0.6 | 1.8 | 1.7 | 1.8 |
| Cheese-like chewy texture | 2.0 | 2.7 | 3.4 | 2.9 |
| Cheese-like springy texture | 1.1 | 2.0 | 2.4 | 2.6 |
| Textural firmness | 4.2 | 3.2 | 2.9 | 4.2 |
| Overall liking | 0.9 | 2.3 | 3.1 | 3.0 |

1. A method of making a flavored article, the method comprising:
(a) providing a comestible composition in a form suitable for extrusion;
(b) extruding the comestible composition to form an extruded comestible composition;
(c) cutting the extruded comestible composition to form one or more comestible articles; and
(d) introducing a flavoring composition to the one or more comestible articles to form one or more flavored articles.

2. The method of claim 1, wherein the comestible composition comprises a non-animal protein, such as a plant protein, an algal protein, a mycoprotein, or any combination thereof.

3. The method of claim 1 or 2, wherein the comestible composition comprises a plant protein.

4. The method of claim 3, wherein the plant protein comprises pea protein, soy protein, or any combination thereof.

5. The method of claim 3 or 4, wherein the plant protein comprises almond protein, cashew protein, canola (rapeseed) protein, chickpea protein, fava protein, sunflower protein, wheat protein, oat protein, potato protein, or any combination thereof.

6. The method of any one of claims 1 to 5, wherein the one or more flavored articles are meat analogue products, seafood analogue products, or dairy analogue products.

7. A method of making a flavored article, the method comprising:
(a) providing a comestible composition in a form suitable for extrusion;
(b) extruding the comestible composition to form an extruded comestible composition;
(c) introducing a flavoring composition to the extruded comestible composition to form a flavored extruded comestible composition; and
(d) cutting the flavored extruded comestible composition to form one or more flavored articles.

8. The method of claim 7, wherein the comestible composition comprises a non-animal protein, such as a plant protein, an algal protein, a mycoprotein, or any combination thereof.

9. The method of claim 7 or 8, wherein the comestible composition comprises a plant protein.

10. The method of claim 9, wherein the plant protein comprises pea protein, soy protein, or any combination thereof.

11. The method of claim 9 or 10, wherein the plant protein comprises almond protein, cashew protein, canola (rapeseed) protein, chickpea protein, fava protein, sunflower protein, wheat protein, oat protein, potato protein, or any combination thereof.

12. The method of any one of claims 7 to 11, wherein the one or more flavored articles are meat analogue products, seafood analogue products, or dairy analogue products.

13. A flavored product formed by the method of any one of claims 1 to 6.

14. A flavored product formed by the method of any one of claims 7 to 12.
